(19) United States
(12) Patent Application Publication
(10) Pub. No.: US 2010/0247732 A1
(43) Pub. Date: Sep. 30, 2010

(54) Stabilizer for Dairy Products

(75) Inventor: Consuelo Cerdena, Valhalla, NY (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: PepsiCo, Inc., Purchase, NY (US)

(21) Appl. No.: 12/788,112

(22) Filed: May 26, 2010

Related U.S. Application Data
(62) Division of application No. 11/434,554, filed on May 15, 2006.

(51) Int. Cl. A23C 9/154

(52) U.S. Cl. 426/575

(57) ABSTRACT

A food stabilizer formed from natural components used in food products. The natural components include microcrystalline cellulose/alginate, native starch, or carrageenan. Effective amounts of the natural components are provided to the food product to maintain physical stability during its shelf life while imparting good mouthfeel. The food stabilizer can be incorporated in dairy-based beverages, such as milkshakes.

This application is a divisional of U.S. application Ser. No. 11/434,554, filed May 15, 2006, which is incorporated herein by reference in its entirety.

### FIELD OF THE INVENTION

The present invention relates generally to food products, and more particularly to stabilizers for dairy products.

### BACKGROUND OF THE INVENTION

Milk-based or dairy products have various health benefits, such as providing calcium to promote healthy bones as well as various vitamins. One problem with dairy products is that they are susceptible to physical instability, decreasing their shelf-life. To promote longer shelf-life, stabilizers are added to the dairy products. Stabilizers also are used to develop texture in dairy products.

Conventionally, artificial stabilizers are used in dairy products. Such stabilizers include carboxymethyl cellulose (CMC) and modified starches. The use of artificial stabilizers, although serving to prolong shelf-life, is undesirable as consumers are becoming more health conscious, demanding natural ingredients. Furthermore, natural stabilizers can be used to achieve thicker mouthfeel, especially when used with low or non-fat dairy products. Accordingly, it is desirable to provide an improved stabilizer for food products.

### SUMMARY OF THE INVENTION

The present invention relates to natural stabilizers used in food products, such as dairy-based products, including beverages or non-dairy based food products. The natural stabilizer can include microcrystalline cellulose (“MCC”)/alginate, a combination of MCC/alginate and native starch, a combination of MCC/alginate and carrageenan, a combination of MCC/alginate, native starch and carrageenan, or a combination of native starch and carrageenan. The carrageenan can include lambda carrageenan, kappa carrageenan or iota carrageenan or a combination thereof. Effective amounts of MCC/alginate, or combinations of MCC/alginate, native starch, or carrageenan, as disclosed above, are added to the food product achieve the desired shelf-life and mouthfeel or texture.

Another embodiment of the invention relates to forming a food product, such as a dairy-based beverage, with a natural stabilizer mixture. Forming the food product includes adding and dissolving a natural stabilizer comprising MCC/alginate, or combinations of MCC/alginate, native starch, or carrageenan, in a liquid. The liquid solution is processed to form the food product. Effective amounts of MCC/alginate, or combinations of MCC/alginate, native starch, or carrageenan, as disclosed above, and are added to the food product to maintain its physical stability through its shelf-life. In one embodiment, a stabilizer mixture can include a combination of carrageenan in amounts of about 0.0010-0.05 weight percent of lambda carrageenan, about 0.0010-0.05 weight percent of kappa carrageenan and 0.1-5.0% weight percent of native starch is added to the food product.

These and other objects, along with advantages and features of the present invention herein disclosed, will become apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF DRAWINGS

The drawing is not to scale, emphasis instead generally being placed upon illustrating the principles of the invention. In the following description, various embodiments of the present invention are described with reference to the following drawing, in which:

FIG. 1 shows processes for forming dairy-based beverages in accordance with different embodiments of the invention.

### DETAILED DESCRIPTION OF THE INVENTION

The present invention relates to natural stabilizers used in food products. In one embodiment, the natural stabilizer is used for dairy products, such as dairy-based beverages. The dairy-based beverage may include milk or milk-derived ingredients, such as milk, condensed milk, cream and powdered milk. The milk or milk-derived ingredients can be, for example, high-, whole-, reduced-, low- or non-fat or skim. Other types of milk or milk-derived ingredients are also useful. Bulk sweeteners such as sucrose or high fructose corn syrup (HFCS), colors and flavorings such as cocoa powder can be added to the beverage. Other types of ingredients may also be added as desired.

The natural stabilizers can also be used with other types of dairy food products, such as milk puddings, yoghurt and yoghurt drinks Providing the natural stabilizer in non-dairy products is also useful. For example, the natural stabilizer can be incorporated in salad dressings, syrups and sauces.

In accordance with one embodiment of the invention, a natural stabilizer mixture for food products comprises MCC/alginate. In accordance with another embodiment of the invention, a natural stabilizer mixture for food products comprises a combination of MCC/alginate and native starch. In accordance with yet another embodiment of the invention, a natural stabilizer mixture for food products comprises a combination of MCC/alginate and carrageenan. In accordance with yet another embodiment of the invention, a natural stabilizer mixture for food products comprises a combination of MCC/alginate, native starch and carrageenan. In accordance with yet another embodiment of the invention, a natural stabilizer mixture for food products comprises a combination of native starch and carrageenan. The carrageenan can include lambda carrageenan, kappa carrageenan, or iota carrageenan, or a combination thereof. Table 1 shows examples of commercially available MCC/alginate, native starch, and carrageenan.

TABLE 1

| MCC/ | NATIVE | LAMBDA | KAPPA | IOTA |
|---|---|---|---|---|
| ALGINATE | STARCH | CARRAGEENAN | CARRAGEENAN | CARRAGEENAN |
| Avicel-plus | Novation | Viscarin GP 209F | Seakem CM 611 | Viscarin SA 318 |
| AC 4125 | 4086 | | | |
| | Novation | Lactarin MV 306 | Kelco K-100 | TICAGEL 385 |
| | 4600 | | | |
| | Novation | | Seekem X-10603 | |
| | 4200 | | | |
| | Novation | | | |
| | 8600 | | | |

Effective amounts of MCC/alginate, or combinations of MCC/alginate, native starch, or carrageenan, are provided to the dairy-based beverage to achieve the desired shelf-life and mouthfeel or texture. In one embodiment, effective amounts of lambda carrageenan, kappa carrageenan and native starch are provided to achieve the desired shelf-life and mouthfeel or texture.

Typically, the desired shelf-life of the product is at least about 6 months at ambient or room temperature, for example 6-12 months, while giving the beverage a texture thicker than conventional whole milk, such as a milkshake consistency. The viscosity of the beverage, for example, can be about 100-800 centipoise. Other shelf-life durations and/or textures are also useful. During its shelf-life, the food product should maintain its physical stability.

In one embodiment, the beverage comprises about 0.0010-0.05 weight % of lambda carrageenan, about 0.0010-0.05 weight % of kappa carrageenan and about 0.1-5.00 weight % of native starch. Preferably, the beverage comprises about 0.0025-0.01 weight % of lambda carrageenan, about 0.0025-0.02 weight % of kappa carrageenan, and about 1.00-3.00 weight % of native starch. All percentages used herein are based on the total weight of the beverage. The natural stabilizer is provided in dry-form, such as powder form. Providing the natural stabilizer in other forms may also be useful.

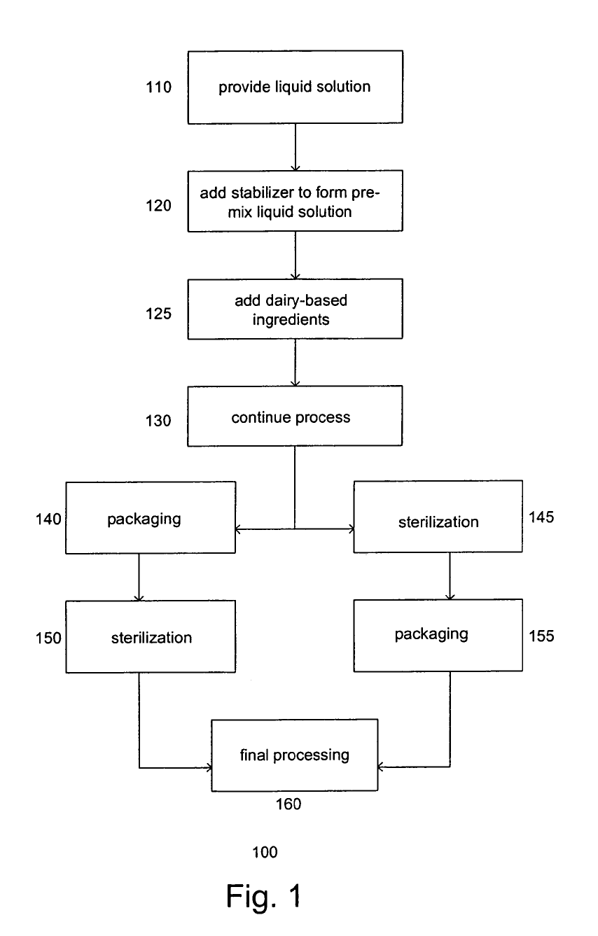

FIG. 1 shows a process for producing a food product in accordance with embodiments of the invention. In one embodiment, a dairy-based product is formed. Preferably, the dairy-based product is a ready-to-drink off-the-shelf beverage. The dairy-based beverage, for example, can be a flavored milk product made from a high-, whole-, reduced-, low- or non-fat or skim milk. In one embodiment, the dairy-based product comprises a milkshake. Other types of dairy-based product such as milk puddings, yoghurt and yoghurt drinks are also useful.

Initially, at step 110, a liquid solution is provided or formed. The liquid, for example, comprises water. Preferably, the water is treated. Treatment of water includes, for example, reverse osmosis.

The liquid provided is about 40-45% of the total amount of liquid used for producing the beverage. Other amounts of liquid may also be useful. The amount of liquid depends on the desired amount of beverage to be made. For example, the concentration of liquid is about 75-49% by weight of the total weight of the beverage. Other percentages are also useful. All percentages used herein are based on the total weight of the beverage.

In accordance with the invention, an effective amount of stabilizer mixture is added to the liquid solution to form a pre-mix liquid solution. The stabilizer mixture, in one embodiment, comprises about 0.0010-0.05 weight % of lambda carrageenan, about 0.0010-0.05 weight % of kappa carrageenan and about 0.1-5.00 weight % of native starch. In one embodiment, the stabilizer mixture is provided as a dry-blend. For example, the stabilizer mixture may be provided in powder form.

Bulk sweeteners, such as sucrose or HFCS can be added to the liquid. Other types of sugar, such as glucose, fructose, dextrose or maltose, are also useful. Typically, about 5-20 weight % of sweetener is added to the liquid solution. Other amounts of sweetener can be added in order to achieve the desired sweetness and/or calorie content in the beverage. The amount of sweetener used may also depend on the flavor of the beverage. For example, a greater amount of sweetener may be desired for a chocolate-flavored beverage than for some other flavors. Other ingredients can also be added. For example, salt may be added for taste enhancement or to act as an electrolyte source. Potassium carbonate (K2CO3) may also be added for initial pH adjustment. Additionally, fruit purees/juices can be added for flavoring. Other flavoring ingredients can also be added.

In one embodiment, the various components added to the liquid are dissolved in a liquefier or high shear mixer. To facilitate dissolving the components in the liquid, it is heated to a temperature of 130-140° F. Other temperatures may also be useful.

In one embodiment, a dairy-based solution is provided. The dairy-based solution comprises, for example, condensed skim milk and cream. Other types of milk product or derivatives are also useful. Typically, the dairy-based solution is stored at about 35-40° F. with gentle agitation. In one embodiment, the dairy-based solution provides the remaining amount of liquid needed to produce the dairy-based beverage. In one embodiment, the dairy-based solution provides the remaining about 55-60% of the total liquid required to produce the dairy-based beverage. Other percentages are also useful.

In one embodiment, a cocoa solution is prepared. The cocoa solution is used to produce a cocoa or chocolate-based flavored beverage. To prepare the cocoa solution, cocoa powdered is added to a liquid in a desired amount.

In one embodiment, the solution comprises about 10% of cocoa powder. Other percentages are also useful. The solution is heated to dissolve the cocoa powder. In one embodiment, the solution is heated to about 185° F. for about 45 minutes. After the cocoa powdered is dissolved, the solution is cooled to about 100° F. Preparing the cocoa solution using other techniques or process parameters is also useful.

In one embodiment, the pre-mix and dairy-based solutions are mixed at step 125. The solutions are mixed in, for example, a blending tank. Depending on the application, the cocoa solution is added to the solution. For example, the cocoa solution is added to produce a chocolate or cocoa flavored beverage or food product. The mixing is performed at a temperature of about 130-140° F. To prepare for mixing, the dairy-based solution may be pre-heated to the blending temperature. The solutions are mixed for about 10-20 minutes and preferably for about 15 minutes. Other blending durations and temperatures may also be useful.

Alternatively, the liquid from the initial liquid solution can be provided by dairy-based solution. In such a case, the flavors or other ingredients can be added as well and blended accordingly.

The process continues by processing the blended solution at step 130. The processing includes adjusting the dairy solids concentration. In one embodiment, the solids concentration is adjusted to about 34-37 weight %. Preferably, the solids concentration is adjusted to about 35%. Other concentrations may also be useful. The solid concentration is adjusted by, for example, the addition of liquid, such as water. During this process, the solution is heated to about 165-170° F.

In one embodiment, the solution is pasteurized by heating the solution sufficiently. In one embodiment, a high temperature short time (HTST) process is used to pasteurize the solution. HTST includes, for example, heating the product solution to about 165-170° F. Other temperatures and time durations may also be useful for the pasteurization process.

The solution is homogenized. In one embodiment, the product solution is homogenized at 3500 psi/500 psi. Alternative pressures may also be useful for homogenization. After homogenization, the solution is cooled to about 40° F.

Further processing is continued by adding flavoring and/or color agents, as desired. Additionally, the solution may be adjusted to the desired pH level and solids concentration. The pH level should be targeted to provide a stable solution. In one embodiment, the pH of the solution is about 6.5-7.4. Preferably, the pH is 7.0. Other pH levels may also be useful.

Various pH adjusters can be used to adjust the pH level of the solution. In one embodiment, K2CO3 is used. In one embodiment, about 20% K2CO3 is added to the solution. Other pH adjusters may also be useful, for example, alkaline orthophosphate, potassium hydroxide, sodium citrate or a combination thereof is provided. As subsequent processing may have an impact on the final pH level, these effects should be taken into consideration. For example, the pH should be set at a higher level if subsequent processing would cause a decrease in pH.

The concentration of solids in the solution can be adjusted as desired. In one embodiment, the solids concentration is adjusted by adding liquid. In one embodiment, the solids concentration is adjusted to achieve the desired concentration range. For example, the final beverage may contain a concentration of about 5-40 weight % total solids, of which about 2-10 weight % is comprised of milk fat solids. Other concentrations may also be useful. The range may be selected based on desired nutritional value, taste, and/or texture. Other considerations may include regulatory and labeling requirements. However, this adjustment may affect the total weight of the final product. To accommodate this change in volume, more stabilizers, as well as other ingredients, may need to be added.

In accordance with one embodiment of the invention, the solution is packaged at step 140. Packaging includes filling the solution into appropriate containers before hermetically sealing the containers. The containers, for example, comprise 8 fl oz size glass bottles. Other types and sizes of containers are also useful. The solution in the containers is then sterilized at step 19. Sterilization may be performed in a batch process in retorts or autoclaves by subjecting the containers to heat in, for example, a steam chamber. In one embodiment, the containers are heated to about 255° F. to achieve a Fo value of at least about 4.0.

After sterilization, final processing is conducted at step 160. In one embodiment, final processing includes cooling the beverages and performing final packaging, such as labeling and boxing.

In another embodiment of the invention, after the pH and solids concentration have been adjusted to the desired level, the liquid is sterilized at step 145. The sterilization process comprises ultra high temperature (UHT) treatment. In one embodiment, UHT treatment includes subjecting the liquid to high temperatures, such as by direct steam injection or steam infusion, or by indirect heating in a heat exchanger. The sterilization is typically conducted in a closed system.

Thereafter, the sterilized liquid is cooled to about 400° F. and aseptically filled into appropriate containers at step 155. Final processing is then performed, such as labeling and boxing, at step 160.

### Examples

Various dairy-based beverages have been prepared in accordance with the process described. Ingredients for different dairy-based beverages are shown in Tables 1-5 as follows:

TABLE 1

| INGREDIENTS | WEIGHT % |
|---|---|
| Milk Fat Solids | 5.500 |
| Milk Solids Non-Fat (MSNF) | 6.000 |
| Sucrose | 13.000 |
| Seakem CM 611 (kappa carrageenan) | 0.015 |
| Viscarin GP 209F (lambda carrageenan) | 0.003 |
| Novation 8600 (native starch) | 2.000 |
| Alkalized Cocoa Powder | 0.100 |
| Flavors (natural) | 0.370 |
| Sodium Chloride | 0.045 |
| LycoPen 2% SG (natural color) | 0.100 |
| Potassium Carbonate | 0.030 |
| Water* | 72.837 |

*Includes moisture from all ingredients

TABLE 2

| INGREDIENTS | WEIGHT % |
|---|---|
| Milk Fat Solids | 5.300 |
| Milk Solids Non-Fat (MSNF) | 4.950 |
| Sucrose | 13.500 |
| Seakem CM 611 (kappa carrageenan) | 0.015 |
| Viscarin GP 209F (lambda carrageenan) | 0.003 |
| Novation 8600 (native starch) | 2.000 |
| Alkalized Cocoa Powder | 2.000 |
| Flavors (natural) | 0.300 |
| Potassium Carbonate | 0.030 |
| Water* | 71.902 |

*Includes moisture from all ingredients

TABLE 3

| INGREDIENTS | WEIGHT % |
|---|---|
| Milk Fat Solids | 4.720 |
| Milk Solids Non-Fat (MSNF) | 4.860 |
| Sucrose | 14.000 |
| Seakem CM 611 (kappa carrageenan) | 0.015 |
| Viscarin GP 209F (lambda carrageenan) | 0.010 |
| Novation 8600 (native starch) | 3.000 |
| Banana Puree (MU-22-04) | 1.000 |
| Flavors (natural) | 1.150 |
| Sodium Chloride | 0.120 |
| Annatto Color 03133 | 0.008 |
| Potassium Carbonate | 0.030 |
| Water* | 71.087 |

*Includes moisture from all ingredients

TABLE 4

| INGREDIENTS | WEIGHT % |
|---|---|
| Milk Fat Solids | 5.500 |
| Milk Solids Non-Fat (MSNF) | 6.000 |
| Sucrose | 13.000 |
| Avicel-plus AC 4125 (MCC/alginate) | 0.80 |
| Novation 8600 (native starch) | 1.00 |
| Sodium citrate | 0.20 |
| Alkalized Cocoa Powder | 0.100 |
| Flavors (natural) | 0.370 |
| Sodium Chloride | 0.045 |
| LycoPen 2% SG (natural color) | 0.100 |
| Potassium Carbonate | 0.030 |
| Water* | 72.855 |

*Includes moisture from all ingredients

TABLE 5

| INGREDIENTS | WEIGHT % |
|---|---|
| Milk Fat Solids | 5.300 |
| Milk Solids Non-Fat (MSNF) | 4.950 |
| Sucrose | 13.500 |
| Avicel-plus AC 4125 (MCC/alginate) | 1.00 |
| Sodium citrate | 0.20 |
| Alkalized Cocoa Powder | 2.000 |
| Flavors (natural) | 0.300 |
| Potassium Carbonate | 0.030 |
| Water* | 72.720 |

*Includes moisture from all ingredients

While the invention has been particularly shown and described with reference to various embodiments, it will be recognized by those skilled in the art that modifications and changes may be made to the present invention without departing from the spirit and scope thereof. The scope of the invention should therefore be determined not with reference to the above description but with reference to the appended claims along with their full scope of equivalents.

What is claimed is:

1. A method for processing a food product comprising:
adding a natural stabilizer to a liquid, the natural stabilizer mixture comprises carrageenan and native starch;
dissolving the natural stabilizer mixture in the liquid to form a pre-mix liquid solution; and
processing the pre-mix liquid solution to form a food product.

2. The method of claim 1 comprising processing a dairy-based beverage.

3. The method of claim 2 wherein the adding of the natural stabilizer mixture comprises adding effective amounts of carrageenan and native starch to maintain physical stability of the base food component during its shelf-life.

4. The method of claim 2 wherein adding the natural stabilizer mixture comprises adding the lambda carrageenan, kappa carrageenan, or iota carrageenan or a combination thereof.

5. The method of claim 2 wherein adding the natural stabilizer mixture comprises adding about 0.0010-0.05 weight percent of lambda carrageenan, about 0.0010-0.05 weight percent of kappa carrageenan and 0.1-5.0% weight percent of native starch.

6. The method of claim 1 wherein the adding the natural stabilizer mixture comprises adding effective amounts of carrageenan and native starch to maintain physical stability of the base food component during its shelf-life.

7. The method of claim 1 wherein adding the natural stabilizer mixture comprises adding the lambda carrageenan, kappa carrageenan, or iota carrageenan or a combination thereof.

8. The method of claim 1 wherein adding the natural stabilizer mixture comprises adding about 0.0010-0.05 weight percent of lambda carrageenan, about 0.0010-0.05 weight percent of kappa carrageenan and 0.1-5.0% weight percent of native starch.

9. The method of claim 1 wherein processing the pre-mix liquid comprises:
adding the pre-mix solution to a dairy-based solution; and
blending the pre-mix and dairy-based solution at an elevated temperature; and sterilizing the solutions.

10. The method of claim 9 wherein the liquid of the pre-mix solution comprises about 0-80 weight percent of the total weight of liquid of the beverage and the dairy-based solution comprises about 20-100 weight percent of the total weight of the liquid of the beverage.

11. The method of claim 9 further comprises:
adjusting the solids of the solutions to a solids target level; and
adjusting pH of the food product to a pH target level.

12. A method for processing a food product comprising:
adding a natural stabilizer to a liquid, the natural stabilizer mixture comprises microcrystalline cellulose/alginate;
dissolving the natural stabilizer mixture in the liquid to form a pre-mix liquid solution; and
processing the pre-mix liquid solution to form a food product.

13. The method of claim 12 comprising processing a dairy-based beverage.

14. The method of claim 13 wherein the adding of the natural stabilizer mixture comprises adding an effective amount of microcrystalline cellulose/alginate to maintain physical stability of the base food component during its shelf-life.

15. The method of claim 13 wherein adding the natural stabilizer mixture comprises adding about 0.10-1.9 weight percent of microcrystalline cellulose/alginate.

16. The method of claim 12 wherein the adding the natural stabilizer mixture comprises adding an effective amount of microcrystalline cellulose/alginate to maintain physical stability of the base food component during its shelf-life.

17. The method of claim 12 wherein adding the natural stabilizer mixture comprises adding about 0.10-1.9 weight percent of microcrystalline cellulose/alginate.

18. The method of claim 12 wherein processing the pre-mix liquid comprises:
adding the pre-mix solution to a dairy-based solution; and
blending the pre-mix and dairy-based solution at an elevated temperature; and
sterilizing the solutions.

19. The method of claim 18 wherein the liquid of the pre-mix solution comprises about 0-80 weight percent of the total weight of liquid of the beverage and the dairy-based solution comprises about 20-100 weight percent of the total weight of the liquid of the beverage.

20. The method of claim 18 further comprises:
adjusting the solids of the solutions to a solids target level; and
adjusting pH of the food product to a pH target level.

21. A method for processing a food product comprising:
adding a natural stabilizer to a liquid, the natural stabilizer mixture comprises microcrystalline cellulose/alginate and native starch;
dissolving the natural stabilizer mixture in the liquid to form a pre-mix liquid solution; and
processing the pre-mix liquid solution to form a food product.

22. The method of claim 21 comprising processing a dairy-based beverage.

23. The method of claim 22 wherein the adding of the natural stabilizer mixture comprises adding effective amounts of microcrystalline cellulose/alginate and native starch to maintain physical stability of the base food component during its shelf-life.

24. The method of claim 23 wherein adding the natural stabilizer mixture comprises adding about 0.10-1.9 weight percent of microcrystalline cellulose/alginate and about 0.1-5.00 weight percent of native starch.

25. The method of claim 21 wherein the adding the natural stabilizer mixture comprises adding effective amounts of microcrystalline cellulose/alginate and native starch to maintain physical stability of the base food component during its shelf-life.

26. The method of claim 21 wherein adding the natural stabilizer mixture comprises adding about 0.10-1.9 weight percent of microcrystalline cellulose/alginate and about 0.1-5.00 weight percent of native starch.

27. The method of claim 21 wherein processing the pre-mix liquid comprises:
adding the pre-mix solution to a dairy-based solution; and
blending the pre-mix and dairy-based solution at an elevated temperature; and
sterilizing the solutions.

28. The method of claim 27 wherein the liquid of the pre-mix solution comprises about 0-80 weight percent of the total weight of liquid of the beverage and the dairy-based solution comprises about 20-100 weight percent of the total weight of the liquid of the beverage.

29. The method of claim 27 further comprises:
adjusting the solids of the solutions to a solids target level; and
adjusting pH of the food product to a pH target level.

30. A method for processing a food product comprising:
adding a natural stabilizer to a liquid, the natural stabilizer mixture comprises microcrystalline cellulose/alginate and carrageenan;
dissolving the natural stabilizer mixture in the liquid to form a pre-mix liquid solution; and
processing the pre-mix liquid solution to form a food product.

31. The method of claim 30 comprising processing a dairy-based beverage.

32. The method of claim 31 wherein the adding of the natural stabilizer mixture comprises adding effective amounts of microcrystalline cellulose/alginate, native starch, and carrageenan and to maintain physical stability of the base food component during its shelf-life.

33. The method of claim 31 wherein adding the natural stabilizer mixture comprises adding the lambda carrageenan, kappa carrageenan, or iota carrageenan or a combination thereof.

34. The method of claim 31 wherein adding the natural stabilizer mixture comprises adding about 0.0010-0.05 weight percent of lambda carrageenan, about 0.0010-0.05 weight percent of kappa carrageenan, 0.1-5.0 weight percent of native starch, and 0.10-1.9 weight percent of microcrystalline cellulose/alginate.

35. The method of claim 30 wherein the adding the natural stabilizer mixture comprises adding effective amounts of microcrystalline cellulose/alginate, native starch, and carrageenan to maintain physical stability of the base food component during its shelf-life.

36. The method of claim 30 wherein adding the natural stabilizer mixture comprises adding the lambda carrageenan, kappa carrageenan, or iota carrageenan or a combination thereof.

37. The method of claim 30 wherein adding the natural stabilizer mixture comprises adding about 0.0010-0.05 weight percent of lambda carrageenan, about 0.0010-0.05 weight percent of kappa carrageenan, 0.1-5.0 weight percent of native starch and 0.10-1.9 weight percent of microcrystalline cellulose/alginate.

38. The method of claim 30 wherein processing the pre-mix liquid comprises:
adding the pre-mix solution to a dairy-based solution;
and blending the pre-mix and dairy-based solution at an elevated temperature; and
sterilizing the solutions.

39. The method of claim 38 wherein the liquid of the pre-mix solution comprises about 0-80 weight percent of the total weight of liquid of the beverage and the dairy-based solution comprises about 20-100 weight percent of the total weight of the liquid of the beverage.

40. The method of claim 38 further comprises:
adjusting the solids of the solutions to a solids target level; and
adjusting pH of the food product to a pH target level.

41. A method for processing a food product comprising:
adding a natural stabilizer to a liquid, the natural stabilizer mixture comprises microcrystalline cellulose/alginate and carrageenan;
dissolving the natural stabilizer mixture in the liquid to form a pre-mix liquid solution; and
processing the pre-mix liquid solution to form a food product.

42. The method of claim 41 comprising processing a dairy-based beverage.

43. The method of claim 42 wherein the adding of the natural stabilizer mixture comprises adding effective amounts of microcrystalline cellulose/alginate, native starch, and carrageenan and to maintain physical stability of the base food component during its shelf-life.

44. The method of claim 42 wherein adding the natural stabilizer mixture comprises adding the lambda carrageenan, kappa carrageenan, or iota carrageenan or a combination thereof.

45. The method of claim 42 wherein adding the natural stabilizer mixture comprises adding about 0.0010-0.05 weight percent of lambda carrageenan, about 0.0010-0.05 weight percent of kappa carrageenan, 0.1-5.0 weight percent of native starch, and 0.10-1.9 weight percent of microcrystalline cellulose/alginate.

46. The method of claim 41 wherein the adding the natural stabilizer mixture comprises adding effective amounts of microcrystalline cellulose/alginate, native starch, and carrageenan to maintain physical stability of the base food component during its shelf-life.

47. The method of claim 41 wherein adding the natural stabilizer mixture comprises adding the lambda carrageenan, kappa carrageenan, or iota carrageenan or a combination thereof.

48. The method of claim 41 wherein adding the natural stabilizer mixture comprises adding about 0.0010-0.05 weight percent of lambda carrageenan, about 0.0010-0.05 weight percent of kappa carrageenan, 0.1-5.0 weight percent of native starch and 0.10-1.9 weight percent of microcrystalline cellulose/alginate.

49. The method of claim 41 wherein processing the pre-mix liquid comprises:
adding the pre-mix solution to a dairy-based solution; and
blending the pre-mix and dairy-based solution at an elevated temperature; and
sterilizing the solutions.

50. The method of claim 49 wherein the liquid of the pre-mix solution comprises about 0-80 weight percent of the total weight of liquid of the beverage and the dairy-based solution comprises about 20-100 weight percent of the total weight of the liquid of the beverage.

51. The method of claim 49 further comprises:
adjusting the solids of the solutions to a solids target level; and
adjusting pH of the food product to a pH target level.
